(19) United States
(12) Patent Application Publication
(10) Pub. No.: US 2025/0390638 A1
(43) Pub. Date: Dec. 25, 2025

(54) METHOD FOR DESIGNING SPATIAL MODE MULTIPLEXER BASED ON DIFFRACTED LIGHT CALCULATION

(71) Applicant: SUN YAT-SEN UNIVERSITY, Guangzhou (CN)

(72) Inventors: Zhaohui LI, Guangzhou (CN); Zhibing LIU, Guangzhou (CN)

(73) Assignee: SUN YAT-SEN UNIVERSITY, Guangzhou (CN)

(21) Appl. No.: 18/915,383

(22) Filed: Oct. 15, 2024

(30) Foreign Application Priority Data
Jun. 25, 2024 (CN) 202410822303.5

(51) Int. Cl. G06F 30/27; G06F 113/00

(52) U.S. Cl. CPC G06F 30/27; G06F 2113/00

(57) ABSTRACT

A method for designing a spatial mode multiplexer based on diffracted light calculation is provided. A gradient of blocks of a phase plate is determined by interference patterns of forward diffracted light and backward diffracted light; and for the iteration of the blocks of the phase plate, an update step is determined using a gradient descent algorithm. According to the method, the design process utilizes the real beam transmission process, which brings higher accuracy compared to digital simulation. At the same time, diffracted light calculation is always performed at the speed of light and is highly parallel, which can improve the efficiency of optimization design.

### CROSS-REFERENCE TO THE RELATED APPLICATIONS

This application is based upon and claims priority to Chinese Patent Application No. 202410822303.5, filed on Jun. 25, 2024, the entire contents of which are incorporated herein by reference.

### TECHNICAL FIELD

The present invention relates to the technical field of space division multiplexing in optical communications, in particular to a method for designing a spatial mode multiplexer based on diffracted light calculation.

### BACKGROUND

Space division multiplexing technology makes full use of the spatial dimension of a light field, and can increase the information transmission capacity of a single fiber by two or more orders of magnitude. Space division multiplexing contains multi-core single-mode, single-core few-mode, multi-core few-mode and other forms. Multi-core few-mode is the combination of multi-core multiplexing and mode multiplexing, which can maximize the transmission capacity density of a single fiber. Cascade diffraction is one of the mode conversion schemes to realize low loss and low crosstalk due to abundant freedom of control thereof. However, the current design of cascade diffraction phase plates still needs simulation by electronic computers, which has the most important drawback of failing to quickly and accurately calculate real diffraction situations.

In some of the existing methods, multiplanar optical conversion techniques are used, and such schemes realize mode conversion by cascading multiple layers of phase plates. In application, the multi-phase plate design needs to simulate the transmission behavior of beams using a digital computer, and optimizes phase plates with the help of a wavefront matching method. Essentially, free-space diffraction-based schemes can be categorized as multi-phase plate modulation, only the intermediate process of transformation is different, and the core of which lies in the multi-phase plate design. The existing multi-phase plate design is less accurate due to the fact that the cascade diffraction technology scheme usually simulates and calculates the transmission process of beams using a digital computer, however, there is always a certain difference between the real physical process and the simulation, which may lead to the inaccuracy of the design. At the same time, as the scale of simulation parameters increases, the speed of digital simulation decreases as the computational complexity rises.

### SUMMARY

In order to overcome the above defects in the prior art, the present invention provides a method for designing a spatial mode multiplexer based on diffracted light calculation, which improves the accuracy and the optimization efficiency.

In order to solve the above-mentioned technical problems, the present invention adopts the following technical solutions.

The present invention provides a method for optimizing a phase plate based on diffracted light calculation. The phase plate is used in a mode multiplexer. Physical light propagation calculation is adopted in a diffraction process. The gradient of blocks of the phase plate is determined by interference patterns of forward diffracted light and backward diffracted light; and for the iteration of the blocks of the phase plate, an update step is determined using a gradient descent algorithm. The method includes the following steps:

S11. constructing a forward diffracted light calculation model Eₖ(Uₘ) for beams, where Uₘ denotes a collimated single-mode light field distribution corresponding to an m^{th} spatial mode, and Eₖ(Uₘ) denotes an output of an m^{th} collimated single-mode light field after undergoing k diffraction propagations, i.e., a forward output light field;

S12. constructing a backward diffracted light calculation model Bₖ(Qₘ), where Qₘ denotes a backward input light field corresponding to the m^{th} spatial mode, and Bₖ(Qₘ) denotes an output of an m^{th} backward input light field after undergoing N−k+1 diffraction propagations, i.e., a backward output light field;

S13. constructing a real-valued objective function L to assess whether the forward output light field Eₖ meets a mode conversion objective, where L is a function of a model output light field Eₘ and a collimation light field Qₘ of a space division multiplexing fiber, and Eₘ is an output light field of a final plane of the forward output light field;

S14. calculating a forward output light field Eₖ(Uₘ) and a backward output light field Bₖ(Qₘ) of each phase block by diffraction, and then calculating an optimization gradient of a plurality of blocks Pₖ of the phase plate based on the objective function L; and

S15. optimizing and updating the phase plate using a gradient descent algorithm.

According to the above technical solution, the design process utilizes the real beam transmission process and does not need to determine the specific propagation mode of beams in advance, so that this design method may bring higher accuracy. At the same time, the present invention does not need to electronically simulate the beam transmission process, and the diffraction calculation is always carried out at the speed of light and is highly parallel, which is conducive to improving the optimization efficiency.

Further, the forward diffracted light calculation model Eₖ(Uₘ) is:

$${E}_{k} ( {U}_{m} ) = {U}_{m} {F}_{1} {M}_{1} {F}_{2} {M}_{2} … {F}_{k - 1} {M}_{k - 1} {F}_{k} {M}_{k}$$

where Uₘ denotes the collimated single-mode light field distribution corresponding to the m^{th} spatial mode, and Eₖ(Uₘ) denotes the output of the m^{th} collimated single-mode light field after undergoing k diffraction propagations; Mk=exp(jPₖ) is a diagonal matrix representing a modulation effect of a k^{th} block Pₖ of the phase plate on beams; and Fₖ denotes a transmission matrix of a k^{th} forward spatial diffraction of the light field, and is determined by a position of starting and ending coordinate planes of the forward diffraction. When diffracted light calculation is adopted, Fₖ does not need to be specifically measured, but is automatically determined by an actual light path, so that accurate and delay-free result output may be achieved.

Further, the backward diffracted light calculation model Bₖ(Qₘ) is:

$${B}_{k} ( {Q}_{m} ) = {Q}_{m} {R}_{N + 1} {M}_{N} {R}_{N} {M}_{N - 1} … {R}_{k + 2} {M}_{k + 1} {R}_{k + 1}$$

where Qₘ denotes the backward input light field corresponding to the m^{th} spatial mode, and Bₖ(Qₘ) denotes the output of the m^{th} backward input light field after undergoing N−k+1 diffraction propagations; and Rₖ denotes a transmission matrix of an (N−k+1) th backward spatial diffraction of the light field, and Rₖ is determined by a position of starting and ending coordinate planes of the backward diffraction and automatically acts on a backward transmission light field.

Further, in step S14, the optimization gradient of the plurality of blocks Pₖ of the phase plate based on the objective function L is calculated using an adjoint method:

$$\frac{\partial L}{\partial {P}_{k}} = - 2 {\sum }_{all m} Im \{ {E}_{k} ( {U}_{m} ) ⊗ {B}_{k} ( \frac{\partial L}{\partial {E}_{m}} ) \}$$

where Im denotes taking an imaginary part of a complex number, and ⊗ denotes element-by-element corresponding multiplication.

Further, step S14 includes:

S141. loading a channel of a fiber array to measure a complex amplitude E_{N+1} of a forward diffraction output mode field, and calculating a gradient

$$\frac{\partial L}{\partial {E}_{N + 1} ( {U}_{m} )}$$

of the objective function L with respect to a forward diffraction output light field;

S142. modulating a phase of a spatial light modulator to produce the following light field as a backward diffraction input:

$${G}_{m} ( ϕ ) = exp ( j ϕ ) \frac{\partial L}{\partial {E}_{N + 1} ( {U}_{m} )} + \overline{{E}_{N + 1} ( {U}_{m} )}$$

where

$$ϕ = \frac{π}{2} and ϕ = \frac{3 π}{2}$$

are used to record light intensities

$${I}_{m , k} ( \frac{π}{2} ) and {I}_{m , k} ( \frac{3 π}{2} )$$

of the k^{th} block of the phase plate, respectively;

S143. deriving an approximate gradient of each phase block from intensity information, the optimization gradient of the phase plate being:

$$\frac{\partial L}{\partial {P}_{k}} \approx - \frac{1}{2} [ {I}_{m , k} ( \frac{3 π}{2} ) - {I}_{m , k} ( \frac{π}{2} ) ]$$

S144. determining an adjustment step of the phase plate using an adaptive moment estimation method, and switching the phase distribution of the k^{th} block of the phase plate with this step, where k=1-N.

The present invention further provides a method for designing a spatial mode multiplexer based on diffracted light calculation. The mode multiplexer includes: a fiber array including M single-mode fibers, where M>=2 and corresponds to the quantity of multiplexed spatial modes; space division multiplexing fibers; a phase plate and a reflector for realizing mode field conversion from the single-mode fiber array to the space division multiplexing fibers. The single-mode fiber array is collimated by a set of correspondingly arranged microlens arrays; the space division multiplexing fibers are coupled using single lenses; the phase plate includes N>=2 blocks for successive phase modulation of incident light; and the phase plate is optimized and updated using the phase plate optimization design method described above.

Further, after the optimization and updating of the phase plate are completed, a phase loaded by the phase plate is a phase of final design, a phase distribution loaded by the phase plate is extracted and converted into a corresponding photolithographic template, and the phase plate is prepared using micro-nano-processing or photolithographic processing to be used for constructing a practical mode multiplexer.

Further, a phase of each pixel on the phase plate is an independently adjustable variable, the phase blocks are connected through light field diffraction of free space, and a plurality of phase blocks are disposed in the same plane. The present invention further provides a method for designing a light path of a mode multiplexer based on diffracted light calculation. The method includes the following steps:

S21. making a phase plate parallel to a plane where a reflector is located, the phase plate including N>=2 phase blocks, initializing a phase distribution of each phase block, and defining an objective function L of a light field of an output plane;

S22. accessing a mode Uₘ of an m^{th} channel of a fiber array, wherein Gaussian beams collimated by a microlens array are converted to the light field E_{N+1}(Uₘ) of the output plane after multiple modulations by the phase plate and reflection by the reflector;

S23. introducing a beam of reference light through single-mode fibers, combining same with the light field E_{N+1}(Uₘ) of the output plane through a beam splitter to form an interference intensity pattern at a camera, and collecting the interference intensity pattern through the camera for Fourier transform, filtering out first-order diffraction, and inverse Fourier transform to recover a complex amplitude of the light field E_{N+1}(Uₘ) of the output plane;

S24. calculating a gradient

$$\frac{\partial L}{\partial {E}_{N + 1} ( {U}_{m} )}$$

of the objective function L with respect to the light field E_{N+1}(Uₘ) of the output plane, inputting same with a light source of the single-mode fibers, modulating a phase of a spatial light modulator to generate the following mode field distribution, and inputting the mode field distribution backward to the phase plate, where the mode field distribution is denoted as:

$${G}_{m} ( ϕ ) = exp ( j ϕ ) \frac{\partial L}{\partial {E}_{N + 1} ( {U}_{m} )} + \overline{{E}_{N + 1} ( {U}_{m} )}$$

and

$$ϕ = \frac{π}{2} and ϕ = \frac{3 π}{2}$$

are used to record light intensities

$${I}_{m , k} ( \frac{π}{2} ) and {I}_{m , k} ( \frac{3 π}{2} )$$

of a k^{th} phase block of the phase plate, respectively;

S25. deriving an optimization gradient of each phase block according to light intensity information:

$$\frac{\partial L}{\partial {P}_{k}} \approx - \frac{1}{2} {I}_{m , k} ( \frac{3 π}{2} ) - {I}_{m , k} ( \frac{π}{2} ) ]$$

S26. substituting the optimization gradient into an adaptive moment estimation method to determine an adjustment step of the phase plate, adjusting a phase distribution Pₖ of the k^{th} phase block of the phase plate with the step, k=1-N, and optimizing and updating the phase plate using a gradient descent algorithm; and

S27. switching an input channel of the fiber array and repeating gradient measurement and update of a loading phase of the spatial light modulator until optimization of the phase plate is completed.

Further, a phase loaded by the phase plate is a phase of final design, and an output light field is coupled to a space division multiplexing fiber through a lens.

Compared with the prior art, the beneficial effects are: According to the method for designing the spatial mode multiplexer based on diffracted light calculation provided by the present invention, the design process utilizes the real beam transmission process, which brings higher accuracy compared to digital simulation. At the same time, diffracted light calculation is always performed at the speed of light and is highly parallel, which may improve the efficiency of optimization design.

### BRIEF DESCRIPTION OF THE DRAWINGS

FIG. 1 shows a schematic flow diagram of a method according to the present invention.

FIG. 2 shows an optimized light path of a spatial mode multiplexer based on diffraction calculation.

FIG. 3 shows design of a phase plate for multiplexing of orbital angular momentum modes.

FIG. 4 shows a multiplexing result of orbital angular momentum modes.

Reference numerals: 1. Fiber array; 2. Microlens array; 3. Phase plate; 4. Light-sensitive panel; 5. Reflector; 6. Lens; 7. Space division multiplexing fiber; 8. Beam splitter; 9. Single-mode fiber; 10. Camera; and 11. Spatial light modulator.

### DETAILED DESCRIPTION OF THE EMBODIMENTS

The technical solutions according to the embodiments of the present invention will be clearly and completely described below with reference to the accompanying drawings in the embodiments of the present invention. Apparently, the described embodiments are merely a part of the embodiments of the present invention, rather than all the embodiments. The present invention is illustrated below in one of the embodiments in combination with specific embodiments. The accompanying drawings are for illustrative purposes only, represent only schematic drawings, not physical drawings, and are not to be construed as limiting the present invention. In order to better illustrate the embodiments of the present invention, some parts of the accompanying drawings may be omitted, enlarged or reduced and do not represent actual product dimensions. It may be appreciated by those skilled in the art that some well-known structures and their descriptions may be omitted from the accompanying drawings.

In the description of the present invention, it is to be understood that the terms “upper”, “lower”, “left”, “right”, etc. indicate orientations or positional relationships based on the orientations or positional relationships shown in the accompanying drawings, and are merely for the convenience of describing the present invention and simplifying the description, rather than indicating or implying that the referred devices or components must have a specific orientation, be constructed and operated in a specific orientation, so the terms used for describing the positional relationship in the accompanying drawings are for illustrative purposes merely and should not be construed as limitations on the present invention. The specific meanings of the above terms will be understood by a person of ordinary skill in the art, depending on the circumstances. Furthermore, if the embodiments of the present invention contain descriptions involving “first”, “second”, etc., the descriptions of “first”, “second”, etc. are used only for descriptive purposes and are not to be construed as indicating or implying relative importance or implicitly indicating the number of technical features indicated. Thus, a feature defined as “first” or “second” may explicitly or implicitly include at least one of the features. In addition, reference to “and/or” throughout this text is meant to include three concurrent solutions, for example, “A and/or B” includes solution A, or solution B, or solutions where both A and B are satisfied.

### Embodiment 1

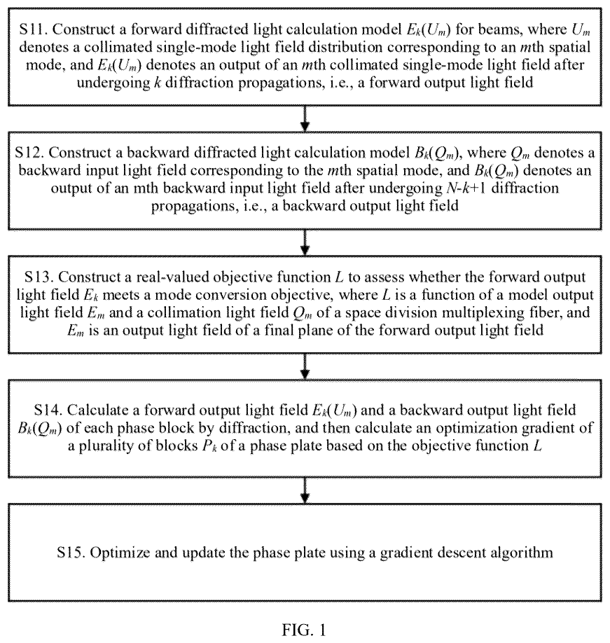

As shown in FIG. 1, this embodiment provides a method for optimizing a phase plate based on diffracted light calculation. The phase plate is used in a mode multiplexer. Physical light propagation calculation is adopted in a diffraction process. The gradient of blocks of the phase plate is determined by interference patterns of forward diffracted light and backward diffracted light; and for the iteration of the blocks of the phase plate, an update step is determined using a gradient descent algorithm. The method includes the following steps:

S11. constructing a forward diffracted light calculation model Eₖ(Uₘ) for beams, where Uₘ denotes a collimated single-mode light field distribution corresponding to an m^{th} spatial mode, and Eₖ(Uₘ) denotes an output of an m^{th} collimated single-mode light field after undergoing k diffraction propagations, i.e., a forward output light field;

S12. constructing a backward diffracted light calculation model Bₖ(Qₘ), where Qₘ denotes a backward input light field corresponding to the m^{th} spatial mode, and Bₖ(Qₘ) denotes an output of an m^{th} backward input light field after undergoing N−k+1 diffraction propagations, i.e., a backward output light field;

S13. constructing a real-valued objective function L to assess whether the forward output light field Eₖ meets a mode conversion objective, where L is a function of a model output light field Eₘ and a collimation light field Qₘ of a space division multiplexing fiber, and Eₘ is an output light field of a final plane of the forward output light field;

S14. calculating a forward output light field Eₖ(Uₘ) and a backward output light field Bₖ(Qₘ) of each phase block by diffraction, and then calculating an optimization gradient of a plurality of blocks Pₖ of the phase plate based on the objective function L; and

S15. optimizing and updating the phase plate using a gradient descent algorithm.

The forward diffracted light calculation model Eₖ(Uₘ) is:

$${E}_{k} ( {U}_{m} ) = {U}_{m} {F}_{1} {M}_{1} {F}_{2} {M}_{2} … {F}_{k - 1} {M}_{k - 1} {F}_{k} {M}_{k}$$

where Uₘ denotes the collimated single-mode light field distribution corresponding to the m^{th} spatial mode, and Eₖ(Uₘ) denotes the output of the m^{th} collimated single-mode light field after undergoing k diffraction propagations; Mk=exp(jPₖ) is a diagonal matrix representing a modulation effect of a k^{th} block Pₖ of the phase plate on beams; and Fₖ denotes a transmission matrix of a k^{th} forward spatial diffraction of the light field, and is determined by a position of starting and ending coordinate planes of the forward diffraction. When diffracted light calculation is adopted, Fₖ does not need to be specifically measured, but is automatically determined by an actual light path, so that accurate and delay-free result output may be achieved.

The backward diffracted light calculation model Bₖ(Qₘ) is:

$${B}_{k} ( {Q}_{m} ) = {Q}_{m} {R}_{N + 1} {M}_{N} {R}_{N} {M}_{N - 1} … {R}_{k + 2} {M}_{k + 1} {R}_{k + 1}$$

where Qₘ denotes the backward input light field corresponding to the m^{th} spatial mode, and Bₖ(Qₘ) denotes the output of the m^{th} backward input light field after undergoing N−k+1 diffraction propagations; and Rₖ denotes a transmission matrix of an (N−k+1)^{th} backward spatial diffraction of the light field, and Rₖ is determined by a position of starting and ending coordinate planes of the backward diffraction and automatically acts on a backward transmission light field.

In step S14, the optimization gradient of the plurality of blocks Pₖ of the phase plate based on the objective function L is calculated using an adjoint method:

$$\frac{\partial L}{\partial {P}_{k}} = - 2 {\sum }_{all m} Im \{ {E}_{k} ( {U}_{m} ) ⊗ {B}_{k} ( \frac{\partial L}{\partial {E}_{m}} ) \}$$

where Im denotes taking an imaginary part of a complex number, and ⊗ denotes element-by-element corresponding multiplication.

In this embodiment, step S14 specifically includes the following steps:

S141. loading a channel of a fiber array to measure a complex amplitude E_{N+1} of a forward diffraction output mode field, and calculating a gradient

$$\frac{\partial L}{\partial {E}_{N + 1} ( {U}_{m} )}$$

of the objective function L with respect to a forward diffraction output light field;

S142. modulating a phase of a spatial light modulator to produce the following light field as a backward diffraction input:

$${G}_{m} ( ϕ ) = exp ( j ϕ ) \frac{\partial L}{\partial {E}_{N + 1} ( {U}_{m} )} + \overline{{E}_{N + 1} ( {U}_{m} )}$$

where

$$ϕ = \frac{π}{2} and ϕ = \frac{3 π}{2}$$

are used to record light intensities

$${I}_{m , k} ( \frac{π}{2} ) and {I}_{m , k} ( \frac{3 π}{2} )$$

of the k^{th} block of the phase plate, respectively;

S143. deriving an approximate gradient of each phase block from intensity information, the optimization gradient of the phase plate being:

$$\frac{\partial L}{\partial {P}_{k}} \approx - \frac{1}{2} [ {I}_{m , k} ( \frac{3 π}{2} ) - {I}_{m , k} ( \frac{π}{2} ) ]$$

S144. determining an adjustment step of the phase plate using an adaptive moment estimation method, and switching the phase distribution Pₖ of the k^{th} block of the phase plate, where k=1-N.

### Embodiment 2

This embodiment provides a method for designing a spatial mode multiplexer based on diffracted light calculation. An input port of the mode multiplexer is a single-mode fiber array. The fiber array includes M single-mode fibers, where M>=2 and corresponds to the quantity of multiplexed spatial modes. In order to reduce the divergence of an outgoing beam of the single-mode fiber array, the array is collimated by a set of correspondingly arranged microlens arrays. The Gaussian beams after collimation are subject to mode conversion through modulation by the phase plate and reflection by a reflector. The phase plate includes N>=2 independent phase blocks. A phase of each pixel on the phase plate is an independently adjustable variable, and the phase blocks are connected through light field diffraction of free space. The plurality of phase blocks are disposed in the same plane, which facilitates simultaneous processing and reduces the complexity of light path adjustment. After the spatial mode field conversion is completed, the beams are output from the other port of the multiplexer and coupled to the corresponding space division multiplexing fibers through single lenses. The gradient of blocks of a phase plate is determined by interference patterns of forward diffracted light and backward diffracted light; and for the iteration of the blocks of the phase plate, an update step is determined using a gradient descent algorithm.

In order to achieve the design optimization of the phase plate, the diffraction process and errors are calculated using physical light propagations.

The forward diffracted light calculation of beams is described by the following model:

$${E}_{k} ( {U}_{m} ) = {U}_{m} {F}_{1} {M}_{1} {F}_{2} {M}_{2} … {F}_{k - 1} {M}_{k - 1} {F}_{k} {M}_{k}$$

where Uₘ denotes a collimated single-mode light field distribution corresponding to an m^{th} spatial mode, and Eₖ(Uₘ) denotes an output of an m^{th} collimated single-mode light field after undergoing k diffraction propagations; Mk=exp(jPₖ) is a diagonal matrix representing a modulation effect of a k^{th} block Pₖ of the phase plate on beams; and Fₖ denotes a transmission matrix of a k^{th} forward spatial diffraction of the light field, and is determined by a position of starting and ending coordinate planes of the forward diffraction. When diffracted light calculation is adopted, Fₖ does not need to be specifically measured, but is automatically determined by an actual light path, so that accurate and delay-free result output may be achieved.

In order to achieve the optimization and iteration of the phase plate, further, the phase plate needs to be corrected backward according to forward output results. In the forward transmission process, both beam modulation and propagation involve only linear processes, and the diffraction process is realized by light calculation simulation. The backward correction calculates the gradient by the backward transfer of errors, and is also realized by light calculation simulation. The backward diffracted light calculation is described by the following model:

$${B}_{k} ( {Q}_{m} ) = {Q}_{m} {R}_{N + 1} {M}_{N} {R}_{N} {M}_{N - 1} … {R}_{k + 2} {M}_{k + 1} {R}_{k + 1}$$

where Qₘ denotes a backward input light field corresponding to the m^{th} spatial mode, and Bₖ(Qₘ) denotes an output of an m^{th} backward input light field after undergoing N−k+1 diffraction propagations; and Rₖ denotes a transmission matrix of an (N−k+1)^{th} backward spatial diffraction of the light field, and is determined by a position of starting and ending coordinate planes of the backward diffraction.

Further, a real-valued objective function L is constructed to assess whether the output light field Eₖ meets a mode conversion objective, where L is a function of a model output light field Eₘ and a collimation light field Qₘ of a space division multiplexing fiber. The optimization gradient of a plurality of blocks Pₖ of the phase plate is calculated based on L using an adjoint method:

$$\frac{\partial L}{\partial {P}_{k}} = - 2 {\sum }_{all m} Im \{ {E}_{k} ( {U}_{m} ) ⊗ {B}_{k} ( \frac{\partial L}{\partial {E}_{m}} ) \}$$

where Im denotes taking an imaginary part of a complex number, and ⊗ denotes element-by-element corresponding multiplication. This part of the calculation is a matrix dot product of low complexity, which does not involve diffraction propagation and is handled by an electronic computer.

To realize the gradient calculation, the forward output light field Eₖ and the backward output light field Bₖ at each phase block need to be calculated by diffraction, which involves the extraction of complex amplitude information. However, the detection of the complex amplitude requires the introduction of a reference light, and the detection of the light field complex amplitude between phase plates is difficult. Thus, this embodiment adopts a strategy in which only the complex amplitude of a light field at the output layer needs to be measured, while the gradient information of the phase plates may be acquired only by detecting the intensities of light fields at other phase plates. The specific process is as follows:
(1). loading a channel of the fiber array to measure a complex amplitude E_{N+1} of a forward diffraction output mode field, and calculating a gradient

$$\frac{\partial L}{\partial {E}_{N + 1} ( {U}_{m} )}$$

of the objective function L with respect to a forward diffraction output light field;
(2) modulating a phase of a spatial light modulator to produce the following light field as a backward diffraction input:

$${G}_{m} ( ϕ ) = exp ( j ϕ ) \frac{\partial L}{\partial {E}_{N + 1} ( {U}_{m} )} + \overline{{E}_{N + 1} ( {U}_{m} )}$$

where

$$ϕ = \frac{π}{2} and ϕ = \frac{3 π}{2}$$

are used to record light intensities

$${I}_{m , k} ( \frac{π}{2} ) and {I}_{m , k} ( \frac{3 π}{2} )$$

of the k^{th} block of the phase plate, respectively; and
(3) deriving an approximate gradient of each phase block from intensity information, the optimization gradient of the phase plate being:

$$\frac{\partial L}{\partial {P}_{k}} \approx - \frac{1}{2} [ {I}_{m , k} ( \frac{3 π}{2} ) - {I}_{m , k} ( \frac{π}{2} ) ]$$

The optimization gradient of the phase plate Pₖ may be obtained from the above process, and further, the optimization and update of the phase plate may be realized in combination with the gradient descent algorithm. The present invention adopts the adaptive moment estimation algorithm to optimize the phase plate, and other algorithms are also applicable, which only bring about differences in optimization step and convergence efficiency. An adjustment step of the phase plate is adopted by the adaptive moment estimation method, and the phase distribution Pₖ of the k^{th} block of the phase plate is switched, where k=1-N.

After the optimization is completed, a phase loaded by the phase plate is a phase of final design. Further, a phase distribution loaded by the phase plate is extracted and converted into a corresponding photolithographic plate, and a corresponding phase plate is prepared using micro-nano-processing technology. Thus, the phase plate may be used to construct a practical mode multiplexer.

### Embodiment 3

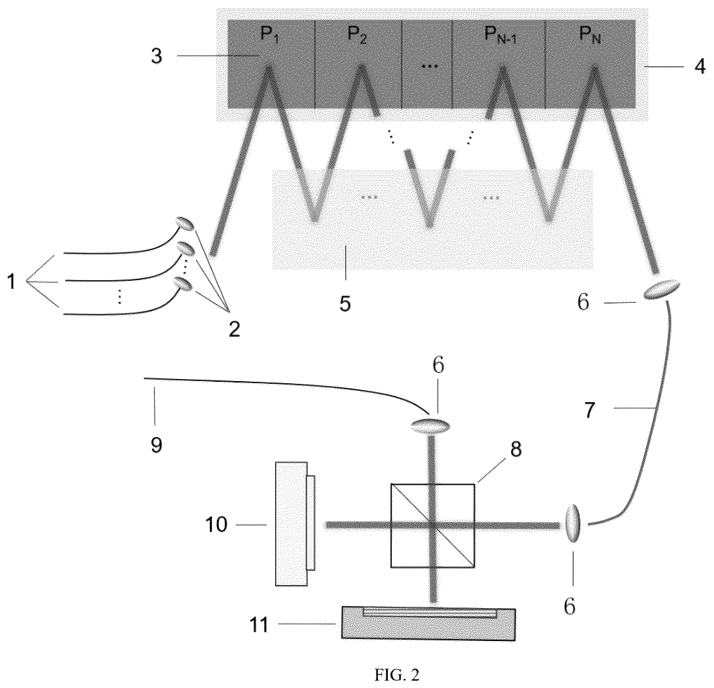

As shown in FIG. 2, this embodiment provides a method for designing a light path of a mode multiplexer based on diffracted light calculation. The method includes the following steps:

S21. making a phase plate 3 parallel to a plane where a reflector 5 is located, the phase plate including N>=2 phase blocks, initializing a phase distribution of each phase block, and defining an objective function L of a light field of an output plane;

S22. accessing a mode Uₘ of an m^{th} channel of a fiber array 1, wherein Gaussian beams collimated by a microlens array 2 are converted to the light field E_{N+1}(Uₘ) of the output plane after multiple modulations by the phase plate and reflection by the reflector 5;

S23. introducing a beam of reference light through single-mode fibers 9, combining same with the light field E_{N+1}(Uₘ) of the output plane through a beam splitter 8 to form an interference intensity pattern at a camera 10, and collecting the interference intensity pattern through the camera 10 for Fourier transform, filtering out first-order diffraction, and inverse Fourier transform to recover a complex amplitude of the light field E_{N+1}(Uₘ) of the output plane;

S24. calculating a gradient

$$\frac{\partial L}{\partial {E}_{N + 1} ( {U}_{m} )}$$

of the objective function L with respect to the light field E_{N+1}(Uₘ) of the output plane, inputting same with a light source of the single-mode fibers 9, modulating a phase of a spatial light modulator 11 to generate the following mode field distribution, and inputting the mode field distribution backward to the phase plate 3, where the mode field distribution is denoted as:

$${G}_{m} ( ϕ ) = exp ( j ϕ ) \frac{\partial L}{\partial {E}_{N + 1} ( {U}_{m} )} + \overline{{E}_{N + 1} ( {U}_{m} )}$$

and

$$ϕ = \frac{π}{2} and ϕ = \frac{3 π}{2}$$

are used to record light intensities

$${I}_{m , k} ( \frac{π}{2} ) and {I}_{m , k} ( \frac{3 π}{2} )$$

of a k^{th} phase block of the phase plate, respectively;

S25. deriving an optimization gradient of each phase block according to light intensity information:

$$\frac{\partial L}{\partial {P}_{k}} \approx - \frac{1}{2} [ {I}_{m , k} ( \frac{3 π}{2} ) - {I}_{m , k} ( \frac{π}{2} ) ]$$

S26. substituting the optimization gradient into an adaptive moment estimation method to determine an adjustment step of the phase plate 3, adjusting a phase distribution Pₖ of the k^{th} phase block of the phase plate 3 with the step, k=1-N, and optimizing and update the phase plate 3 using a gradient descent algorithm; and

S27. switching an input channel of the fiber array 1 and repeating gradient measurement and update of a loading phase of the spatial light modulator 11 until optimization of the phase plate is completed.

A phase loaded by the phase plate 3 is a phase of final design, and an output light field is coupled to a space division multiplexing fiber 7 through a lens 6.

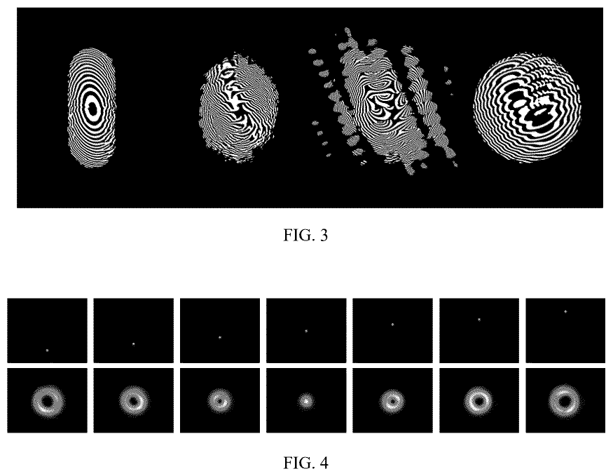

FIG. 3 shows a set of phase image design for multiplexing of orbital angular momentum modes, which contains four phase blocks, to produce orbital angular momentum modes of −3-+3 orders. The input into single-mode fibers and the intensity distribution of the multiplexing of orbital angular momentum modes is shown in FIG. 4. The phase plate 3 may be further replaced with a highly reflective glass sheet or

silicon wafer fabricated by photolithography to improve the energy efficiency of the phase plate.

In the description of this specification, reference to the description of the terms “one embodiment”, “some embodiments”, “example”, “specific example”, or “some examples”, etc. means that the specific features, structures, materials, or characteristics described in connection with the embodiment or example are included in at least one embodiment or example of the present invention. In this specification, schematic representations of the above terms are not to be construed as necessarily referring to the same embodiment or example. Furthermore, the specific features, structures, materials, or characteristics described may be combined in any suitable manner in any one or more embodiments or examples. In addition, without contradicting each other, a person skilled in the art may combine and integrate different embodiments or examples and features of different embodiments or examples described in this specification.

Apparently, the above embodiments of the present invention are merely examples of the present invention for purposes of clarity and are not intended to limit the implementations of the present invention. Changes or modifications in other different forms may also be made by a person of ordinary skill in the art on the basis of the above description. All implementations need not to be, and cannot be, exhaustive. Any modifications, equivalent replacements, improvements, etc. made within the spirit and principle of the present invention shall fall within the scope of protection of the claims of the present invention.

What is claimed is:

1. A method for optimizing a phase plate based on diffracted light calculation, wherein the phase plate is used in a mode multiplexer, physical light propagation calculation is adopted in a diffraction process, and the method comprises the following steps:
S11: constructing a forward diffracted light calculation model Eₖ(Uₘ) for beams, wherein Uₘ denotes a collimated single-mode light field distribution corresponding to an m^{th} spatial mode, and Eₖ(Uₘ) denotes an output of an m^{th} collimated single-mode light field after undergoing k diffraction propagations, wherein Eₖ(Uₘ) is a forward output light field;
S12: constructing a backward diffracted light calculation model Bₖ(Qₘ), wherein Qₘ denotes a backward input light field corresponding to the m^{th} spatial mode, and Bₖ(Qₘ) denotes an output of an m^{th} backward input light field after undergoing N−k+1 diffraction propagations, wherein Bₖ(Qₘ) is a backward output light field;
S13: constructing a real-valued objective function L to assess whether the forward output light field Ex meets a mode conversion objective, wherein L is a function of a model output light field Eₘ and a collimation light field Qₘ of a space division multiplexing fiber, and Eₘ is an output light field of a final plane of the forward output light field;
S14: calculating a forward output light field Eₖ(Uₘ) and a backward output light field Bₖ(Qₘ) of each phase block by diffraction, and then calculating an optimization gradient of a plurality of blocks Pₖ of the phase plate based on the real-valued objective function L; and
S15: optimizing and updating the phase plate using a gradient descent algorithm.

2. The method for optimizing the phase plate based on diffracted light calculation according to claim 1, wherein the forward diffracted light calculation model Eₖ(Uₘ) is:
$${E}_{k} ( {U}_{m} ) = {U}_{m} {F}_{1} {M}_{1} {F}_{2} {M}_{2} … {F}_{k - 1} {M}_{k - 1} {F}_{k} {M}_{k}$$
wherein Uₘ denotes the collimated single-mode light field distribution corresponding to the m^{th} spatial mode, and Eₖ(Uₘ) denotes the output of the m^{th} collimated single-mode light field after undergoing k diffraction propagations; Mₖ=exp(jPₖ) is a diagonal matrix representing a modulation effect of a k^{th} block Pₖ of the phase plate on the beams; and Fₖ denotes a transmission matrix of a k^{th} forward spatial diffraction of a first light field, and Fₖ is determined by a position of starting and ending coordinate planes of a forward diffraction.

3. The method for optimizing the phase plate based on diffracted light calculation according to claim 2, wherein the backward diffracted light calculation model Bₖ(Qₘ) is:
$${B}_{k} ( {Q}_{m} ) = {Q}_{m} {R}_{N + 1} {M}_{N} {R}_{N} {M}_{N - 1} … {R}_{k + 2} {M}_{k + 1} {R}_{k + 1}$$
wherein Qₘ denotes the backward input light field corresponding to the m^{th} spatial mode, and Bₖ(Qₘ) denotes the output of the m^{th} backward input light field after undergoing N−k+1 diffraction propagations; and Rₖ denotes a transmission matrix of an (N−k+1)^{th} backward spatial diffraction of a second light field, and Rₖ is determined by a position of starting and ending coordinate planes of a backward diffraction and automatically acts on a backward transmission light field.

4. The method for optimizing the phase plate based on diffracted light calculation according to claim 3, wherein in step S14, the optimization gradient of the plurality of blocks Pₖ of the phase plate is calculated based on the real-valued objective function L using an adjoint method:
$$\frac{\partial L}{\partial {P}_{k}} = - 2 {\sum }_{all m} Im \{ {E}_{k} ( {U}_{m} ) ⊗ {B}_{k} ( \frac{\partial L}{\partial {E}_{m}} ) \}$$
wherein Im denotes taking an imaginary part of a complex number, and ⊗ denotes element-by-element corresponding multiplication.

5. The method for optimizing the phase plate based on diffracted light calculation according to claim 4, wherein step S14 comprises:
S141: loading a channel of a fiber array to measure a complex amplitude E_{N+1} of a forward diffraction output mode field, and calculating a gradient
$$\frac{\partial L}{\partial {E}_{N + 1} ( {U}_{m} )}$$
of the real-valued objective function L with respect to a forward diffraction output light field;
S142: modulating a phase of a spatial light modulator to produce the following light field as a backward diffraction input:
$${G}_{m} ( ϕ ) = exp ( j ϕ ) \frac{\partial L}{\partial {E}_{N + 1} ( {U}_{m} )} + \overline{{E}_{N + 1} ( {U}_{m} )}$$
wherein
$$ϕ = \frac{π}{2} and ϕ = \frac{3 π}{2}$$
are used to record light intensities
$${I}_{m , k} ( \frac{π}{2} ) and {I}_{m , k} ( \frac{3 π}{2} )$$
of the k^{th} block of the phase plate, respectively;
S143: deriving an approximate gradient of each phase block from intensity information, wherein the optimization gradient of the phase plate is:
$$\frac{\partial L}{\partial {P}_{k}} \approx - \frac{1}{2} [ {I}_{m , k} ( \frac{3 π}{2} ) - {I}_{m , k} ( \frac{π}{2} ) ] ;$$
and S144: determining an adjustment step of the phase plate using an adaptive moment estimation method, and switching a phase distribution Pₖ of the k^{th} block of the phase plate, wherein k=1-N.

6. A method for designing a spatial mode multiplexer based on diffracted light calculation, wherein the spatial mode multiplexer comprises:
a single-mode fiber array comprising M single-mode fibers, wherein M>=2 and corresponds to a quantity of multiplexed spatial modes;
space division multiplexing fibers; and
a phase plate and a reflector for realizing mode field conversion from the single-mode fiber array to the space division multiplexing fibers;
wherein the single-mode fiber array is collimated by a set of correspondingly arranged microlens arrays; the space division multiplexing fibers are coupled using single lenses; the phase plate comprises N>=2 blocks for successive phase modulation of incident light; and the phase plate is optimized and updated using the method for optimizing the phase plate based on diffracted light calculation according to claim 1.

7. The method for designing the spatial mode multiplexer based on diffracted light calculation according to claim 6, wherein after an optimization and updating of the phase plate are completed, a phase loaded by the phase plate is a phase of final design, a phase distribution loaded by the phase plate is extracted and converted into a photolithographic template, the phase plate is prepared using micro-nano-processing or photolithographic processing, and a final optimized phase plate is obtained to be used in the spatial mode multiplexer.

8. The method for designing the spatial mode multiplexer based on diffracted light calculation according to claim 6, wherein a phase of each pixel on the phase plate is an independently adjustable variable, a plurality of phase blocks are connected through light field diffraction of free space, and the plurality of phase blocks are disposed in a same plane.

9. A method for designing a light path of a mode multiplexer based on diffracted light calculation, comprising the following steps:
S21: making a phase plate parallel to a plane where a reflector is located, the phase plate comprising N>=2 phase blocks, initializing a phase distribution of each phase block, and defining an objective function L of a light field of an output plane;
S22: accessing a mode Uₘ of an m^{th} channel of a fiber array, wherein Gaussian beams collimated by a microlens array are converted to the light field E_{N+1}(Uₘ) of the output plane after multiple modulations by the phase plate and reflection by the reflector;
S23: introducing a beam of reference light through single-mode fibers, combining the beam of reference light with the light field E_{N+1}(Uₘ) of the output plane through a beam splitter to form an interference intensity pattern at a camera, collecting the interference intensity pattern through the camera for Fourier transform, filtering out first-order diffraction, and performing inverse Fourier transform to recover a complex amplitude of the light field E_{N+1}(Uₘ) of the output plane;
S24: calculating a gradient
$$\frac{\partial L}{\partial {E}_{N + 1} ( {U}_{m} )}$$
of the objective function L with respect to the light field E_{N+1}(Uₘ) of the output plane, inputting the gradient
$$\frac{\partial L}{\partial {E}_{N + 1} ( {U}_{m} )}$$
with a light source of the single-mode fibers, modulating a phase of a spatial light modulator to generate a mode field distribution, and inputting the mode field distribution backward to the phase plate, wherein the mode field distribution is denoted as:
$${G}_{m} ( ϕ ) = exp ( j ϕ ) \frac{\partial L}{\partial {E}_{N + 1} ( {U}_{m} )} + \overline{{E}_{N + 1} ( {U}_{m} )}$$
and
$$ϕ = \frac{π}{2} and ϕ = \frac{3 π}{2}$$
are used to record light intensities
$${I}_{m , k} ( \frac{π}{2} ) and {I}_{m , k} ( \frac{3 π}{2} )$$
of a k^{th} phase block of the phase plate, respectively;
S25: deriving an optimization gradient of each phase block according to light intensity information:
$$\frac{\partial L}{\partial {P}_{k}} \approx - \frac{1}{2} [ {I}_{m , k} ( \frac{3 π}{2} ) - {I}_{m , k} ( \frac{π}{2} ) ]$$
S26: substituting the optimization gradient into an adaptive moment estimation method to determine an adjustment step of the phase plate, adjusting a phase distribution Pₖ of the kth phase block of the phase plate with the adjustment step, k=1-N, and optimizing and updating the phase plate using a gradient descent algorithm; and
S27: switching an input channel of the fiber array and repeating gradient measurement and update of a loading phase of the spatial light modulator until optimization of the phase plate is completed.

10. The method for designing the light path of the mode multiplexer based on diffracted light calculation according to claim 9, wherein a phase loaded by the phase plate is a phase of final design, and an output light field is coupled to a space division multiplexing fiber through a lens.

11. The method for designing the spatial mode multiplexer based on diffracted light calculation according to claim 6, wherein in the method for optimizing the phase plate based on diffracted light calculation, the forward diffracted light calculation model Eₖ(Uₘ) is:
$${E}_{k} ( {U}_{m} ) = {U}_{m} {F}_{1} {M}_{1} {F}_{2} {M}_{2} … {F}_{k - 1} {M}_{k - 1} {F}_{k} {M}_{k}$$
wherein Uₘ denotes the collimated single-mode light field distribution corresponding to the m^{th} spatial mode, and Eₖ(Uₘ) denotes the output of the m^{th} collimated single-mode light field after undergoing k diffraction propagations; Mk-exp(jPₖ) is a diagonal matrix representing a modulation effect of a k^{th} block Pₖ of the phase plate on the beams; and Fₖ denotes a transmission matrix of a k^{th} forward spatial diffraction of the light field, and Fₖ is determined by a position of starting and ending coordinate planes of a forward diffraction.

12. The method for designing the spatial mode multiplexer based on diffracted light calculation according to claim 11, wherein in the method for optimizing the phase plate based on diffracted light calculation, the backward diffracted light calculation model Bₖ(Qₘ) is:
$${B}_{k} ( {Q}_{m} ) = {Q}_{m} {R}_{N + 1} {M}_{N} {R}_{N} {M}_{N - 1} … {R}_{k + 2} {M}_{k + 1} {R}_{k + 1}$$
wherein Qₘ denotes the backward input light field corresponding to the m^{th} spatial mode, and Bₖ(Qₘ) denotes the output of the m^{th} backward input light field after undergoing N−k+1 diffraction propagations; and Rₖ denotes a transmission matrix of an (N−k+1)^{th} backward spatial diffraction of the light field, and Rₖ is determined by a position of starting and ending coordinate planes of a backward diffraction and automatically acts on a backward transmission light field.

13. The method for designing the spatial mode multiplexer based on diffracted light calculation according to claim 12, wherein in step S14 of the method for optimizing the phase plate based on diffracted light calculation, the optimization gradient of the plurality of blocks Pₖ of the phase plate is calculated based on the real-valued objective function L using an adjoint method:
$$\frac{\partial L}{\partial {P}_{k}} = - 2 {\sum }_{all m} Im \{ {E}_{k} ( {U}_{m} ) ⊗ {B}_{k} ( \frac{\partial L}{\partial {E}_{m}} ) \}$$
wherein Im denotes taking an imaginary part of a complex number, and ⊗ denotes element-by-element corresponding multiplication.

14. The method for designing the spatial mode multiplexer based on diffracted light calculation according to claim 13, wherein step S14 of the method for optimizing the phase plate based on diffracted light calculation comprises:
S141: loading a channel of a fiber array to measure a complex amplitude E_{N+1} of a forward diffraction output mode field, and calculating a gradient
$$\frac{\partial L}{\partial {E}_{N + 1} ( {U}_{m} )}$$
of the real-valued objective function L with respect to a forward diffraction output light field;
S142: modulating a phase of a spatial light modulator to produce the following light field as a backward diffraction input:
$${G}_{m} ( ϕ ) = exp ( j ϕ ) \frac{\partial L}{\partial {E}_{N + 1} ( {U}_{m} )} + \overline{{E}_{N + 1} ( {U}_{m} )}$$
wherein
$$ϕ = \frac{π}{2} and ϕ = \frac{3 π}{2}$$
are used to record light intensities
$${I}_{m , k} ( \frac{π}{2} ) and {I}_{m , k} ( \frac{3 π}{2} )$$
of the k^{th} block of the phase plate, respectively;
S143: deriving an approximate gradient of each phase block from intensity information, wherein the optimization gradient of the phase plate is:
$$\frac{\partial L}{\partial {P}_{k}} \approx - \frac{1}{2} [ {I}_{m , k} ( \frac{3 π}{2} ) - {I}_{m , k} ( \frac{π}{2} ) ] ;$$
and
S144: determining an adjustment step of the phase plate using an adaptive moment estimation method, and switching a phase distribution Pₖ of the k^{th} block of the phase plate, wherein k=1-N.

15. The method for designing the spatial mode multiplexer based on diffracted light calculation according to claim 11, wherein after an optimization and updating of the phase plate are completed, a phase loaded by the phase plate is a phase of final design, a phase distribution loaded by the phase plate is extracted and converted into a photolithographic template, the phase plate is prepared using micro-nano-processing or photolithographic processing, and a final optimized phase plate is obtained to be used in the spatial mode multiplexer.

16. The method for designing the spatial mode multiplexer based on diffracted light calculation according to claim 11, wherein a phase of each pixel on the phase plate is an independently adjustable variable, a plurality of phase blocks are connected through light field diffraction of free space, and the plurality of phase blocks are disposed in a same plane.

17. The method for designing the spatial mode multiplexer based on diffracted light calculation according to claim 12, wherein after an optimization and updating of the phase plate are completed, a phase loaded by the phase plate is a phase of final design, a phase distribution loaded by the phase plate is extracted and converted into a photolithographic template, the phase plate is prepared using micro-nano-processing or photolithographic processing, and a final optimized phase plate is obtained to be used in the spatial mode multiplexer.

18. The method for designing the spatial mode multiplexer based on diffracted light calculation according to claim 12, wherein a phase of each pixel on the phase plate is an independently adjustable variable, a plurality of phase blocks are connected through light field diffraction of free space, and the plurality of phase blocks are disposed in a same plane.

19. The method for designing the spatial mode multiplexer based on diffracted light calculation according to claim 13, wherein after an optimization and updating of the phase plate are completed, a phase loaded by the phase plate is a phase of final design, a phase distribution loaded by the phase plate is extracted and converted into a photolithographic template, the phase plate is prepared using micro-nano-processing or photolithographic processing, and a final optimized phase plate is obtained to be used in the spatial mode multiplexer.

20. The method for designing the spatial mode multiplexer based on diffracted light calculation according to claim 13, wherein a phase of each pixel on the phase plate is an independently adjustable variable, a plurality of phase blocks are connected through light field diffraction of free space, and the plurality of phase blocks are disposed in a same plane.
